(19) United States
(12) Patent Application Publication
(10) Pub. No.: US 2018/0016992 A1
(43) Pub. Date: Jan. 18, 2018

(54) NEURAL NETWORK FOR COMBUSTION SYSTEM FLAME DETECTION

(71) Applicant: GENERAL ELECTRIC COMPANY, Schenectady, NY (US)

(72) Inventors: Prabhanjana Kalya, Hyderabad (IN); Abhijit Kulkarni, Hyderabad (IN); Vikas Handa, Hyderabad (IN); Pradeep Kumar Vavilala, Hyderabad (IN); Vamshi Kandula, Hyderabad (IN)

(21) Appl. No.: 15/208,263

(22) Filed: Jul. 12, 2016

(51) Int. Cl. F02C 9/54

(52) U.S. Cl. CPC F02C 9/54; F05D 2270/44; F05B 2270/20; F05B 2270/504; F05B 2270/709

(57) ABSTRACT

A system includes a processor configured to execute an artificial neural network (ANN). The processor is configured to receive one or more operational parameters associated with an operation of a turbine system. The turbine system includes one or more combustors. The processor is further configured to analyze, via the ANN, the one or more operational parameters to determine a characteristic pattern, and to generate, via the ANN, an output based at least in part on the determined characteristic pattern. The output includes an indication of an intensity of a flame of the one or more combustors to determine a presence or an absence of the flame.

### BACKGROUND

The invention relates generally to combustion systems and more specifically to neural networks for flame detection in combustion systems.

Combustion systems within gas turbine systems, or other similar systems may include a number of sensors to measure and/or detect the various operating parameters of the combustion systems, and by extension, the operating parameters of the systems (e.g., gas turbine systems, and so forth) including the combustion systems. However, these sensors may be limited in their accuracy and reliability in detecting certain data (e.g., flame intensity) of the combustion systems. It may be useful to provide systems and methods to improve data detection of combustion systems.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

A system includes a processor configured to execute an artificial neural network (ANN). The processor is configured to receive one or more operational parameters associated with an operation of a turbine system. The turbine system includes one or more combustors. The processor is further configured to analyze, via the ANN, the one or more operational parameters to determine a characteristic pattern, and to generate, via the ANN, an output based at least in part on the determined characteristic pattern. The output includes an indication of an intensity of a flame of the one or more combustors.

A non-transitory computer-readable medium having code stored thereon, the code includes instructions to cause a processor to receive one or more operational parameters associated with an operation of a turbine system. The turbine system includes one or more combustors. The code includes instructions to cause the processor to execute an artificial neural network (ANN) to analyze the one or more operational parameters to determine a characteristic pattern, and to cause the processor to utilize the ANN to generate an output based at least in part on the determined characteristic pattern. The output includes an indication of an intensity of a flame of the one or more combustors.

A system includes a data analytics system including an artificial neural network (ANN) configured to receive a first operational parameter, a second operational parameter, and a third operational parameter associated with an operation of a gas turbine system. The gas turbine system comprises a plurality of combustors; analyze, via the ANN, at least one of the first operational parameter, the second operational parameter, and the third operational parameter to determine a characteristic pattern of the at least one of the first operational parameter, the second operational parameter, and the third operational parameter, and to generate, via the ANN, an output based at least in part on the determined characteristic pattern. The output includes an indication of an intensity of a flame of the one or more combustors to determine the presence or absence of the combustor flame. The system includes a controller configured to receive the output and to generate a control command based thereon.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of a gas turbine system including a combustion system, in accordance with an embodiment;

FIG. 2 is a diagram of an embodiment of the system of FIG. 1, including an analytics system and artificial neural network (ANN) system, in accordance with an embodiment;

FIG. 3 is a diagram of an embodiment of the ANN system of FIG. 2, in accordance with an embodiment; and

FIG. 4 is a flowchart illustrating an embodiment of a process useful in utilizing artificial neural networks (ANN) to “learn” and recognize patterns indicative of the presence and/or absence of a combustion system flame, in accordance with an embodiment.

### DETAILED DESCRIPTION

One or more specific embodiments of the invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the invention, the articles “a,” “an,” “the,” and “said” are intended to mean that there are one or more of the elements. The terms “comprising,” “including,” and “having” are intended to be inclusive and mean that there may be additional elements other than the listed elements.

Present embodiments relate to systems and methods useful in utilizing neural networks, such as artificial neural networks (ANN) to “learn” and recognize patterns to model flame intensity, and thereby determine the presence or absence of combustor flame. For example, the present embodiments may include an analytics system that utilizes an ANN to recognize and “learn” patterns of flame intensity using certain turbine operating parameters as inputs to the ANN. These operating parameters may include compressor discharge pressure (e.g., CPD), turbine shaft speed (e.g., TNH), exhaust pressure, shaft power, generator power output (e.g., DWATT), differential pressure between manifold fuel pressure and CPD (e.g., 96gn), and so forth. In one embodiment, the ANN may be trained “online” (e.g., during operation) under varying operating conditions to “learn” characteristic patterns associated with ignition and presence and/or absence of combustion flame and/or flame intensity corresponding to normal operation. In another embodiment, the ANN may be trained “offline” (e.g., when operation has ceased) based on known flame-out data, unsuccessful gas turbine system ignition data and successful gas turbine ignition data. In this way, the analytics system utilizing the ANN may determine lean blowouts (LBOs), rich blowouts (RBOs) and the presence and/or absence of combustor flame more accurately, efficiently and reliably than what could otherwise be achievable utilizing any of various flame sensors.

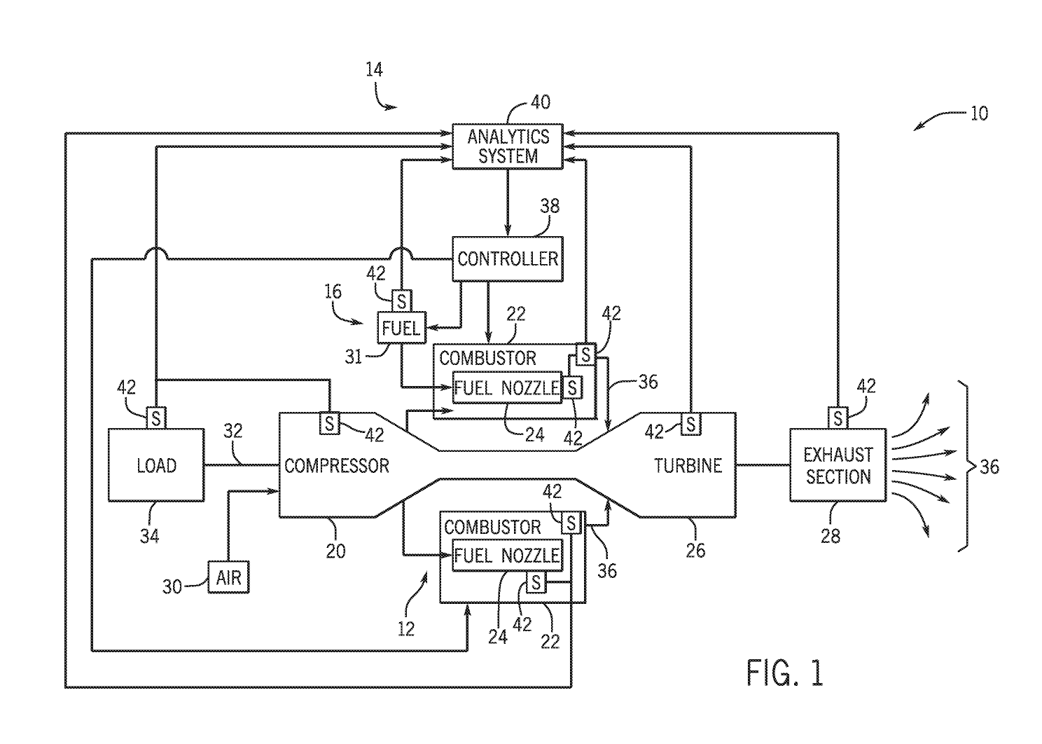

With the foregoing in mind, it may be useful to describe an embodiment of a gas turbine system, such as an example gas turbine system 10 illustrated in FIG. 1. In certain embodiments, the gas turbine system 10 may include a gas turbine system 12, a control system 14, and a fuel supply system 16. As illustrated, the gas turbine system 12 may include a compressor 20, combustion chambers 22, fuel nozzles 24, a turbine 26, and an exhaust section 28. During operation, the gas turbine combustion system 12 may take in air 30 into the compressor 20. The compressor 20 may then compress and move the air 30 to the combustion chambers 22 (e.g., chambers including a number of combustors or burners).

In certain embodiments, the combustion chambers 22, using the fuel nozzles 24, may take in fuel 31 that mixes with the now compressed air 30 creating an air-fuel mixture. The air-fuel mixture may combust within the combustion chambers 22 to generate hot combustion gases, which flow downstream into the turbine 26 to drive the turbine 26. For example, the combustion gases may move through the turbine 26 to drive one or more stages of blades of the turbine 26, which may in turn drive rotation of a shaft 32. The shaft 32 may connect to a load 34, which may include, for example, a generator to convert the output of the shaft 32 into electric power. In certain embodiments, upon passing through the turbine 26, the hot combustion gases may vent into the environment as exhaust gases 36 via the exhaust section 28. The exhaust gas 36 may include major species such as, for example, carbon dioxide (CO₂), nitrogen (N₂), water vapor (H₂O), and oxygen (O₂), as well as minor species (e.g., pollutants) such as, for example, carbon monoxide (CO), nitrogen oxides (NOₓ), unburned hydrocarbons (UHC), and sulfur oxides (SOₓ).

In certain embodiments, the control system 14 may include a controller 38 communicatively coupled to an analytics system 40, and a number of sensors 42. The analytics system 40 may receive data relating to one or more components of the gas turbine system 12 detected by the sensors 42, and generate and transmit outputs to the controller 38 based on an analysis of the data detected by the sensors 42. For example, as will be further appreciated, the analytics system 40 may use the sensor 42 data to determine, for example, CO₂ levels in the exhaust gas 36, pollutant (e.g., CO, NOₓ, UHC, SOₓ) levels in the exhaust gas 36, carbon content in the fuel 31, temperature of the fuel 31, lower heating value of fuel and other fuel properties. temperature, pressure, clearance (e.g., distance between stationary and rotating components), flame temperature or intensity, vibration, compressor 20 discharge pressure (e.g., CPD), shaft 32 speed (e.g., TNH), generator power output (e.g., DWATT), combustor 22 combustion dynamics (e.g., fluctuations in pressure, flame intensity, and so forth), and load data from load 34

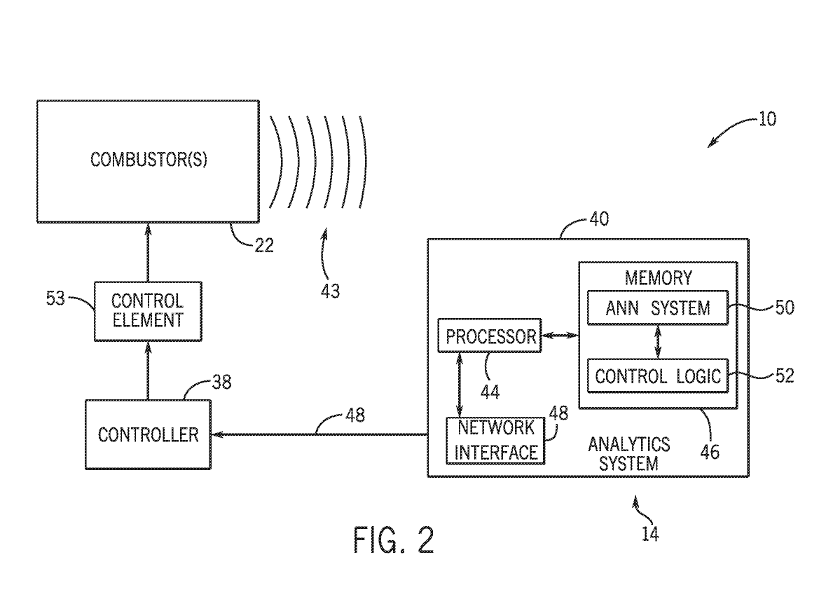

Indeed, as will be further appreciated, the analytics system 40 may detect lean blowouts (LBOs) (e.g., loss of flame due to a decrease in air-fuel ratio), rich blowouts (RBOs), presence of combustor 22 flame, and loss of combustor 22 flame based on one or more artificial neural network (ANN) outputs generated based on certain operating parameters (e.g., compressor 20 discharge pressure [CPD], shaft 32 speed [TNH], generator power output [DWATT], and so forth) of the gas turbine system 12. In other words, as will be further appreciated with respect to FIGS. 2-4 the analytics system 40 may detect lean blowouts (LBOs), Rich blowouts (RBOs), presence of combustor 22 flame, and loss of combustor 22 flame without directly utilizing sensor 42 flame detection data (e.g., without the use of colorimeters, flame sensors, wavefront sensors, photodiodes, infra-red sensors, pyrometers, ultraviolet pyrometers, and so forth). In this way, the analytics system 40 may detect LBOs, RBOs, and the presence and/or absence of combustor 22 flame more reliably than what could otherwise be achievable utilizing any of various flame sensors because flame sensors may be susceptible to erroneous readings of flame intensity (e.g., due to movement of the combustor 22 flame away from the line of sight of the flame sensor).

Turning now to FIG. 2, which illustrates an embodiment of the control system 14. In certain embodiments, the analytics system 40 may be any hardware system, or, in other embodiments, a combination of a hardware and software system, suitable for analyzing, deriving, and/or modeling combustion data (e.g., flame 43 intensity), and/or other data relating to the combustion chambers 22 of the gas turbine system 12. As illustrated, the analytics system 40 may include one or more processors 44, a memory 46 (e.g., storage), input/output (I/O) ports (e.g., one or more network interfaces 48), and so forth, useful in implementing the techniques described herein. Particularly, the analytics system 40 may include code or instructions stored in a non-transitory machine-readable medium (e.g., the memory 46 and/or storage) and executed, for example, by the one or more processors 44 that may be included in the analytics system 40. Additionally, the analytics system 40 may include a network interface 48, which may allow communication between the analytics system 40 and the controller 38 sensors 42 and actuators via a personal area network (PAN), a local area network (LAN) (e.g., Wi-Fi), a wide area network (WAN), a physical connection (e.g., an Ethernet connection), and/or the like.

In certain embodiments, the analytics system 40 may receive and/or derive compressor 20 discharge pressure (CPD), shaft 32 speed, generator power output (e.g., DWATT) data based on the inputs received from the sensors 42. For example, as previously noted, the analytics system 40 may use the data collected by the sensors 42, to detect presence of combustor 22 flame 43, or loss of combustor 22 flame 43, flame 43 intensity, and so forth. Specifically, as previously noted above with respect to FIG. 1, the analytics system 40 may accurately detect and indicate the aforementioned combustion data (e.g., presence of combustor 22 flame 43, and loss of combustor 22 flame 43) without directly utilizing sensor 42 flame detection data.

Thus, in certain embodiments, the analytics system 40 may utilize an artificial neural network (ANN) system 50 (e.g., which may be stored in the memory 46) to “learn” and recognize patterns in certain operating parameters (e.g., compressor 20 discharge pressure [CPD], shaft 32 speed, generator power output, and so forth) of the gas turbine system 12 associated with the presence and/or the loss of combustor 22 flame 43 at various operating and loading conditions of the gas turbine system 12. For example, the ANN system 50 may utilize one or more probabilistic techniques such as, for example, neural networks having several layers of nodes, such as one or more input layer, one or more output layer, and one or more hidden layer between the input and output layers. The ANN system 50 may be supplemented with statistical methods (e.g., linear regression, non-linear regression, ridge regression, data mining) in addition to artificial intelligence models (e.g., expert systems, fuzzy logic, support vector machines [SVMs], logic reasoning systems, and so forth) to improve certainty in prognosis and/or diagnostics of the operating conditions of the of the combustors 22 (and more specifically, the status of the flame 43 of the combustors 22), and by extension, the gas turbine system 12.

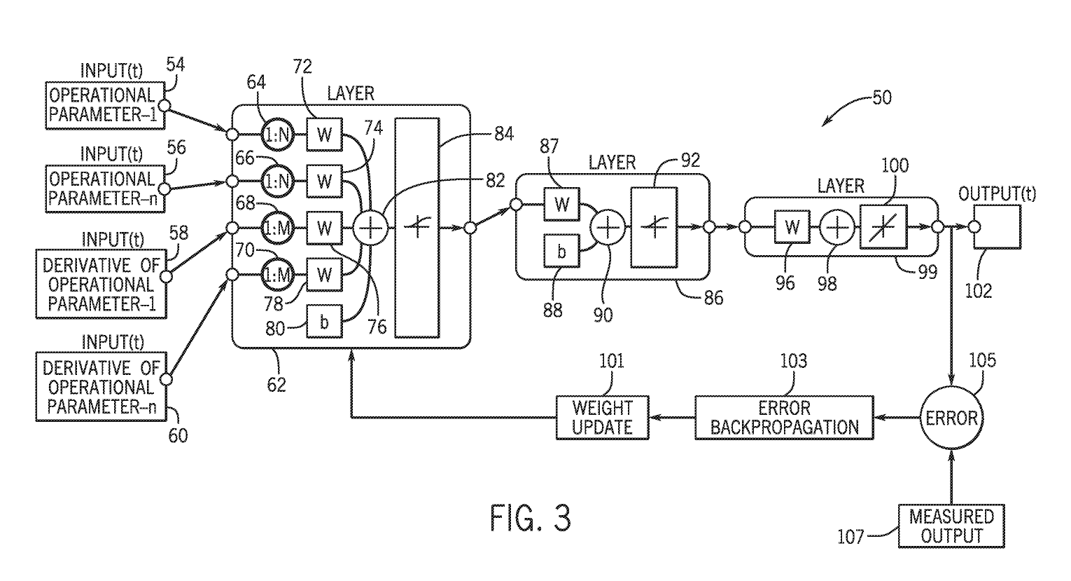

Additionally, as will be discussed further with respect to FIG. 3, the ANN system 50 may also be trained offline with available flame-out data. For example, gas turbine system 12 operating characteristics associated with turbine 26 and compressor 20, ignition, presence of combustor 22 flame 43 and combustor 22 LBOs such as, for example, rate, acceleration, slump, swing, and so forth with respect the aforementioned gas turbine system 12 operating parameters may be “learned” by the ANN system 50 for each configuration and mode of operation of the gas turbine system 12. Furthermore, in some embodiments, the ANN system 50 may monitor the gas turbine system 12 parameters in real time to identify and “learn” certain patterns or signatures (e.g., distinctive characteristics) associated with turbine 26 and compressor 20, ignitions, presence of combustor 22 flames 43 and combustor 22 LBOs, RBOs to determine the status of the flame 43 of the combustors 22. It should be appreciated that, in some embodiments, the analytics system 40 may be programmably retrofitted with instructions to execute presently disclosed techniques.

As further illustrated in FIG. 2, the ANN system 50 may interface with control logic 52. In one embodiment, the control logic 52 may include any logic (e.g., a combination of hardware circuitry and software) that may be used to generate logical value (“0” or “1”) to the controller 38 to perform one or more control actions. For example, based on the status of the flame 43 of the combustors 22, the analytics system 40 may transmit one or more logical values (e.g., “0” or “1”) to the controller 38 to execute one or more control actions. For example, in one embodiment, the controller 38 may output a control signal to control one or more control elements 53 (e.g., actuators, valves, trim valves, inlet guide vanes) to execute a control action to alter operating parameters including, for example, compressor 20 inlet airflow, compressor 20 exit airflow, flow of fuel 31 to the combustion chambers 22, and so forth, to adjust and stabilize the flame output 43 of the combustion chambers 22, and by extension, the power output of the gas turbine system 12.

Turning now to FIG. 3, an embodiment of the architecture of the ANN system 50 is illustrated. In some embodiments, the architecture of the ANN system 50, as illustrated by FIG. 3, may be referred to as a “perceptron.” Furthermore, while the present embodiments of the ANN system 50 may be discussed with respect to, for example, a feedforward artificial neural network, in other embodiments, the ANN system 50 may include a feedback artificial neural network. As depicted, the ANN system 50 may receive operational parameters, for example, a compressor 20 discharge input 54 (e.g., “CPD”), a shaft 32 speed input 56 (e.g., “TNH”), a CPD derivative input 58 (e.g., “D_CPD”), and a TNH derivative input 60 (e.g., “D_TNH”). The operational parameters may be respectively transmitted to a sum and activation layer 62 (e.g., 10 neuron layer). As depicted, the sum and input layer 62 may include respective input delay blocks 64 (“1:N” e.g., “1:5”), 66 (“1:N” e.g., “1:5”), 68 (“1:M” e.g., “1:3”), and 70 (“1:M” e.g., “1:3”). Subsequently to the respective inputs 54, 56, 58, and 60 having respective delays applied via the input delay blocks 64, 66, 68, and 70, the respective inputs 54, 56, 58, and 60 may be then weighted via perceptron weights 72, 74, 76, and 78. In certain embodiments, the perceptron weights 72, 74, 76, and 78, may be used, for example, to amplify and/or attenuate the respective inputs 54, 56, 58, and 60.

In certain embodiments, the respective inputs 54, 56, 58, and 60 having been weighted via the perceptron weights 72, 74, 76, and 78 and an arbitrary perceptron bias 80 may be summed (e.g., added) via a summer block 82. The summed input signal may be then transmitted to an activation function block 84. In certain embodiments, the activation function block 84 may be used to convert the summed input signal into a filtered useable form (e.g., by removing undesirable frequency harmonics). For example, in one embodiment, the activation function block 84 may include a low pass filter, a high pass filter, a bandpass filter, a step function, or other function that may be used to filter the summed input signal. As further depicted in FIG. 3, the summed and filtered input signal may be then transmitted to a second layer/hidden layer 86 (e.g., 5 neuron layer). Specifically, the summed and filtered input signal may weighted via a perceptron weight 87 and arbitrary perceptron bias 88 and summed (e.g., added) via a summer block 90. A logarithmic function may be then applied to the signal via logarithmic activation function block 92.

In certain embodiments, as further depicted by the ANN system 50 of FIG. 3, the signal may be then transmitted to a third layer/output layer 99 (e.g. 1 neuron layer) where the signal may be again weighted via a perceptron weight 96 and summed (e.g., added) via a summer block 98. The signal may be then transmitted to a linear activation function block 100 before an output signal is generated via an output layer 102 (e.g., “Output”). The ANN system 50 may also include a weight update block 101, an error back-propagation block 103, an error summer 105, and a measured output block 107 for providing feedback to the sum and activation layer 62. In one embodiment, the output signal of the ANN system 50 may be a median of a triple modular redundant (TMR) minimum flame 43 intensity variable. More specifically, control embodiments of the controller 38 may include a TMR controller having three cores (e.g., R, S, T cores) suitable for providing redundant operations. For example, as previously discussed, the output signal of the ANN system 50 may include an indication of an impending lean blowouts (LBOs) (e.g., loss of flame due to a decrease in air-fuel ratio), presence of combustor 22 flame, and loss of combustor 22 flame based on one or more artificial neural network (ANN) outputs generated based certain operating parameters (e.g., compressor 20 discharge pressure [CPD], shaft 32 speed, generator power output, and so forth) of the gas turbine system 12.

Furthermore, as previously noted with respect to FIG. 2, the ANN system 50 may “learn” and recognize patterns in certain operating parameters (e.g., compressor 20 discharge input 54 (“CPD”), the shaft 32 speed input 56 (“TNH”), the CPD derivative input 58 (“D_CPD”), and the TNH derivative input 60 (“D_TNH”)) of the gas turbine system 12 associated with the presence and/or the loss of combustor 22 flame 43 at various operating and loading conditions of the gas turbine system 12. Specifically, the ANN system 50 may generate a training data set to construct a knowledgebase of gas turbine system 12 operating parameters' characteristics associated with ignition, presence of combustor 22 flame 43 and combustor 22 flame blowout such as, for example, rate, acceleration, slump, swing, and so forth such that the aforementioned gas turbine system 12 operating parameters may be “learned” by the ANN system 50 for each configuration and mode of operation of the gas turbine system 12. Once the ANN has learned the operating parameters' characteristics associated with flame it can then be used to control the fuel flow or air flow. For example, in one embodiment, the gas turbine system 12 operating parameters (e.g., compressor 20 discharge pressure [CPD], shaft 32 speed, generator power output, and so forth) may exhibit significant dependency on the presence of combustor 22 flame, such that the operating parameters may increase (e.g., rate increase) upon successful ignition and markedly decrease (e.g., rate decrease) in the event of, for example, an LBO. In this way, the analytics system 40 may determine the presence or absence of combustor 22 flame more accurately and efficiently than what could otherwise be achievable utilizing any of various flame sensors.

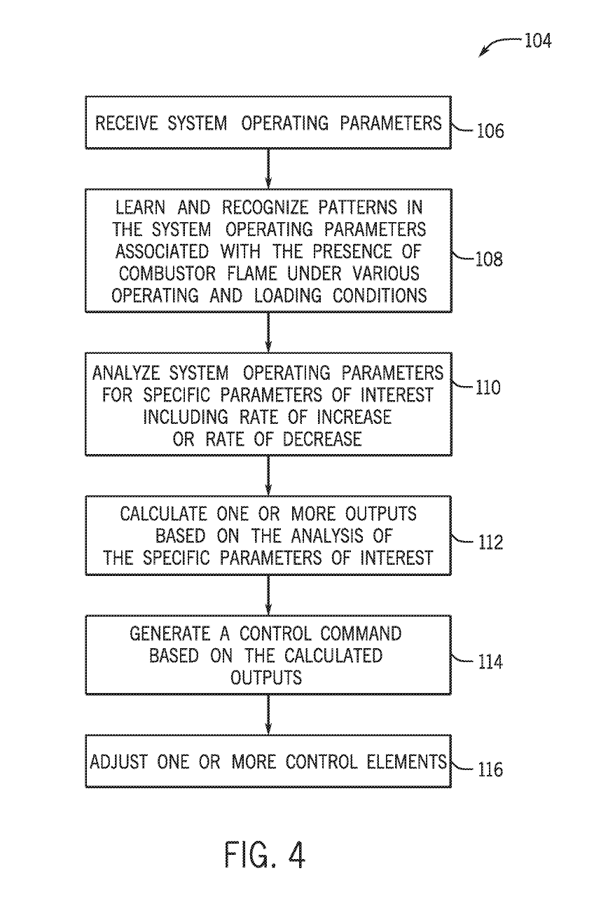

Turning now to FIG. 4, a flow diagram is presented, illustrating an embodiment of a process 104 useful in utilizing artificial neural networks (ANN) to “learn” and recognize patterns indicative of the presence or absence of combustion flame by using, for example, the analytics system 40 in conjunction with the controller 38 depicted in FIG. 2. The process 104 may include code or instructions stored in a non-transitory computer-readable medium (e.g., the memory 46) and executed, for example, by the one or more processors 44 included in the analytics system 40 and/or processors included within the controller 38. The process 104 may begin with the analytics system 40 receiving (block 106) system operating parameters of the gas turbine system 12. For example, the analytics system 40 may receive compressor 20 discharge pressure (CPD), shaft 32 speed (TNH), generator power output (DWATT), and so forth.

The process 104 may then continue with the analytics system 40 “learning” and recognizing (block 108) in the system operating parameters associated with the presence or absence of combustor flame under various operating and loading conditions. For example, as noted above with respect to FIGS. 2 and 3, the analytics system 40 may utilize an ANN system 50 to “learn” and recognize patterns in certain operating parameters (e.g., compressor 20 discharge pressure [CPD], shaft 32 speed, generator power output, and so forth) of the gas turbine system 12 associated with the presence and/or the loss of combustor 22 flame 43 at various operating and loading conditions of the gas turbine system 12. The analytics system 40 may then analyze (block 110) the system operating parameters for specific parameters of interest including rate of increase or rate of decrease.

For example, the gas turbine system 12 operating parameters (e.g., compressor 20 discharge pressure [CPD], shaft 32 speed, generator power output, and so forth) may exhibit significant dependency on the presence of combustor 22 flame. Indeed, these operating parameters of the gas turbine system 12 may increase (e.g., rate increase) upon successful ignition and markedly decrease (e.g., rate decrease) in the event of, for example, an LBO. In some embodiments, the gas turbine system 12 operating parameter rate of increase and/or rate of decrease may be dependent upon certain design and operating conditions such as, for example, rated base load, shaft 32 power and output configuration (e.g., generator drive, mechanical drive, grid connected, islanding mode, droop control, isochronous mode, and so forth). The analytics system 40 may utilize the ANN system 50 to “learn” and recognize all patterns in the aforementioned operating parameters and conditions of the gas turbine system 12.

The process 104 may then continue with the analytics system 40 calculating (block 112 one or more outputs based on the analysis of the specific parameters of interest. For example, the ANN system 50 of the analytics system 40 may generate an output indicative of the presence and/or absence of combustor 22 flame. The process 104 may then continue with the analytics system 40 generating (block 114) a control command based on the calculated outputs. The calculated one or more outputs may be then transmitted to the controller 38 and used by the controller 38 to adjust (block 116) one or more control elements 53 (e.g., control elements 53 such as actuators, valves, trip commands, etc.) coupled to the combustors 22 or other components of the gas turbine system 12. For example, one or more actuator and/or control valve signals may be generated by the controller 38 to stop, for example, the fuel flow to the combustors 22, and by extension, the fuel (e.g., fuel 31) flow to the gas turbine system 12. In this way, the analytics system 40 may determine LBOs and the presence or absence of combustor 22 flame 43 more reliably and lead to replacement of one or more physical flame detector from the gas turbine design.

Technical effects of the present embodiments relate to systems and methods useful in utilizing neural networks, such as artificial neural networks (ANN) to “learn” and recognize patterns to model flame intensity, and thereby determine the presence or absence of combustor flame. For example, the present embodiments may include an analytics system that utilizes an ANN to recognize and “learn” patterns of flame intensity using certain turbine operating parameters as inputs to the ANN. These operating parameters may include compressor discharge pressure (e.g., CPD), turbine shaft speed (e.g., TNH), exhaust pressure, shaft power, generator power output (e.g., DWATT), differential pressure between manifold fuel pressure and CPD (e.g., 96gn), and so forth. In one embodiment, the ANN may be trained “online” (e.g., during operation) under varying operating conditions to “learn” characteristic patterns associated with ignition and presence and/or absence of combustion flame and/or flame intensity corresponding to normal operation. In another embodiment, the ANN may be trained “offline” (e.g., when operation has ceased) based on known flame-out data, unsuccessful gas turbine system ignition data and successful gas turbine ignition data. In this way, the analytics system utilizing the ANN may determine lean blowouts (LBOs), rich blowouts (RBOs) and the presence and/or absence of combustor flame more accurately, efficiently and reliably than what could otherwise be achievable utilizing any of various flame sensors.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A system, comprising:
a processor configured to execute an artificial neural network (ANN), and configured to:
receive one or more operational parameters associated with an operation of a turbine system, wherein the turbine system comprises one or more combustors;
analyze, via the ANN, the one or more operational parameters to determine a characteristic pattern; and
generate, via the ANN, an output based at least in part on the determined characteristic pattern, wherein the output comprises an indication of an intensity of a flame of the one or more combustors to determine a presence or an absence of the flame.

2. The system of claim 1, wherein the processor is configured to receive a compressor discharge pressure (CPD) input as the one or more operational parameters.

3. The system of claim 1, wherein the processor is configured to receive a turbine shaft speed as the one or more operational parameters.

4. The system of claim 1, wherein the processor is configured to receive an exhaust temperature, a mechanical energy input, an electrical energy input, a differential pressure, or a combination thereof, as the one or more operational parameters.

5. The system of claim 1, wherein the ANN comprises a feedforward ANN comprising at least three layers.

6. The system of claim 1, wherein the processor is configured to learn the characteristic pattern over a plurality of operating conditions of the turbine system.

7. The system of claim 1, wherein the processor is configured to analyze the one or more operational characteristics to determine a rate of increase or a rate of decrease of the one or more operational parameters as the determined characteristic pattern.

8. The system of claim 1, wherein the processor is configured to generate the output comprising an indication of a flame blowout of the one or more combustors.

9. The system of claim 1, comprising a controller configured to receive the output and to execute a control action for controlling at least one component coupled to the turbine system.

10. The system of claim 9, wherein the controller is configured to execute the control action comprising actuating an actuator, and wherein the actuator is configured to control a flow of fuel into the one or more combustors.

11. The system of claim 9, wherein the controller is configured to execute the control action comprising actuating an actuator, and wherein the actuator is configured to control a flow of air into the one or more combustors.

12. The system of claim 1, wherein the processor is configured to be programmably retrofitted with instructions to:
analyze, via the ANN, the one or more operational parameters to determine the characteristic pattern; and
generate, via the ANN, the output based at least in part on the determined characteristic pattern.

13. A non-transitory computer-readable medium having computer executable code stored thereon, the code comprising instructions to:
cause a processor to receive one or more operational parameters associated with an operation of a turbine system, wherein the turbine system comprises one or more combustors;
cause the processor to execute an artificial neural network (ANN) to analyze the one or more operational parameters to determine a characteristic pattern; and
cause the processor to utilize the ANN to generate an output based at least in part on the determined characteristic pattern, wherein the output comprises an indication of an intensity of a flame of the one or more combustors.

14. The non-transitory computer-readable medium of claim 13, wherein the code comprises instructions to cause the processor to receive a compressor discharge pressure (CPD) input as the one or more operational parameters.

15. The non-transitory computer-readable medium of claim 13, wherein the code comprises instructions to cause the processor to receive a turbine shaft speed as the one or more operational parameters.

16. The non-transitory computer-readable medium of claim 13, wherein the code comprises instructions to cause the processor to receive an exhaust temperature, a mechanical energy input, an electrical energy input, a differential pressure, or a combination thereof, as the one or more operational parameters.

17. The non-transitory computer-readable medium of claim 13, wherein the code comprises instructions to cause the processor to learn the characteristic pattern over a plurality of operating conditions of the turbine system.

18. The non-transitory computer-readable medium of claim 13, wherein the code comprises instructions to cause the processor to determine a rate of increase or a rate of decrease of the one or more operational parameters as the determined characteristic pattern.

19. A system, comprising:
a data analytics system comprising an artificial neural network (ANN) configured to:
receive a first operational parameter, a second operational parameter, and a third operational parameter associated with an operation of a gas turbine system, wherein the gas turbine system comprises a plurality of combustors;
analyze, via the ANN, at least one of the first operational parameter, the second operational parameter, and the third operational parameter to determine a characteristic pattern of the at least one of the first operational parameter, the second operational parameter, and the third operational parameter; and
generate, via the ANN, an output based at least in part on the determined characteristic pattern, wherein the output comprises an indication of an intensity of a flame of the one or more combustors to determine the presence or absence of the combustor flame; and
a controller configured to receive the output and to generate a control command based thereon.

20. The system of claim 19, wherein the controller is configured to generate the control command to adjust an inlet airflow, an exit airflow, an exit pressure, an inlet fuel flow, or a combination thereof, of the plurality of combustors.
